(19) United States
(12) Patent Application Publication
(10) Pub. No.: US 2026/0220765 A1
(43) Pub. Date: Jul. 30, 2026

(54) METHOD FOR DETECTING WELDING DEFECTS, METHOD FOR EVALUATING WELDING DEFECTS, CONTROL DEVICE, WELDING SYSTEM, AND DETECTION PROGRAM

(71) Applicant: Kabushiki Kaisha Kobe Seiko Sho (Kobe Steel, Ltd.), Kobe-shi (JP)

(72) Inventors: Keita OZAKI, Kobe-shi (JP); Junichi KAWATA, Kobe-shi (JP); Keito ISHIZAKI, Kobe-shi (JP)

(73) Assignee: Kabushiki Kaisha Kobe Seiko Sho (Kobe Steel, Ltd.), Kobe-shi (JP)

(21) Appl. No.: 19/374,569

(22) Filed: Oct. 30, 2025

(30) Foreign Application Priority Data
Jan. 24, 2025 (JP) 2025-010838

(51) Int. Cl. G06T 7/00

(52) U.S. Cl. CPC G06T 7/001; G06T 2207/30136

(57) ABSTRACT

A method for detecting welding defects includes a first step of obtaining at least an image of a welding location during welding, a second step of extracting information regarding at least a porosity defect among the welding defects on a basis of the image, a third step of classifying the porosity defect into one of two or more occurrence types of porosity defect on a basis of the information regarding at least the porosity defect, and a fourth step of extracting at least one occurrence type of porosity defect and calculating quantitative data relating to the porosity defect.

### BACKGROUND OF THE INVENTION

### 1. Field of the Invention

The present invention relates to a method for detecting welding defects, a method for evaluating welding defects, a control device, a welding system, and a detection program.

### 2. Description of the Related Art

During arc welding, welding defects might occur due to various factors. Welding defects affect quality of welded structures to be fabricated. Accordingly, it has been conventionally required to detect welding defects in real-time during welding in order to improve welding quality. The higher the accuracy of the detection, the more effectively results of the detection can be utilized for improving the welding quality, such as suppression the occurrence of welding defects and enhanced traceability after the welding.

Japanese Unexamined Patent Application Publication No. 2021-167010 describes a welding observation apparatus. The welding observation apparatus observes a molten region in arc welding and includes first imaging means for capturing an image of a weld pool formed at the molten region and a first detection unit that detects bubbles caused in the weld pool from the image of the weld pool captured by the first imaging means.

Japanese Unexamined Patent Application Publication No. 2023-69564 describes a welding observation apparatus. The welding observation apparatus observes a molten region in arc welding and includes a bubble detection unit that detects bubbles caused in the molten region, a cumulative number calculation unit that calculates a cumulative number of bubbles detected by the bubble detection unit for each of analysis sections having a predetermined travel distance in the arc welding, and a welding defect detection unit that detects occurrence of welding defects on the basis of the cumulative number for each analysis section.

### SUMMARY OF THE INVENTION

Welding defects occur due to various factors. For example, the welding defects include porosity defects such as pits and blowholes. One of factors causing the porosity defects is shielding gas failure due to wind, nozzle clogging caused by sputter, or the like. The porosity defects also originate from plating, such as in a galvanized steel plate, and moisture and oil adhering to a surface of a steel plate. There is also a plurality of factors causing each of types of welding defects other than the porosity defects.

In order to utilize the results of the detection of welding defects for suppressing the occurrence of welding defects, it is necessary to appropriately control a welding system on the basis of the results of the detection, but in such control, not only the detection accuracy but also identification of factors causing the welding defects is important. Furthermore, even when the results of the detection are utilized for the traceability after welding, if the factors that have caused the welding defects are identified, more detailed information can be obtained. In the examples of the related art, however, no means has been considered for detecting welding defects while identifying factors causing the welding defects.

The present invention has been made in view of the above problems, and an object thereof is to provide a method for detecting welding defects, a method for evaluating welding defects, a control device, a welding system, and a detection program by which welding defects can be detected for each of factors causing welding defects.

The present invention has the following configurations.

(1) A method for detecting welding defects, the method including a first step of obtaining at least an image of a welding location during welding, a second step of extracting information regarding at least a porosity defect among the welding defects on a basis of the image, a third step of classifying the porosity defect into one of two or more occurrence types of porosity defect on a basis of the information regarding at least the porosity defect, and a fourth step of extracting at least one occurrence type of porosity defect and calculating quantitative data relating to the porosity defect.

(2) A method for evaluating welding defects, the method including a first step of obtaining at least an image of a welding location during welding, a second step of extracting information regarding at least a porosity defect among the welding defects on a basis of the image, a third step of classifying the porosity defect into one of two or more occurrence types of porosity defect on a basis of the information regarding at least the porosity defect, a fourth step of extracting at least one occurrence type of porosity defect and calculating quantitative data relating to the porosity defect, a fifth step of predicting welding defect information after the welding, an amount of any element contained in molten metal, or an amount of deposits on a surface of a workpiece on a basis of the quantitative data, and a sixth step of evaluating presence or absence of at least the porosity defect on a basis of a predicted value of the welding defect information, the amount of any element, or the amount of deposits.

(3) A control device for detecting welding defects, the control device including a control unit, in which the control unit obtains at least an image of a welding location during welding, extracts information regarding at least a porosity defect among the welding defects on a basis of the image, classifies the porosity defect into one of two or more occurrence types of porosity defect on a basis of the information regarding at least the porosity defect, extracts at least one occurrence type of porosity defect, and calculates quantitative data relating to the porosity defect.

(4) A welding system for detecting welding defects, the welding system including a control device, in which the control device obtains at least an image of a welding location during welding, extracts information regarding at least a porosity defect among the welding defects on a basis of the image, classifies the porosity defect into one of two or more occurrence types of porosity defect on a basis of the information regarding at least the porosity defect, extracts at least one occurrence type of porosity defect, and calculates quantitative data relating to the porosity defect.

(5) A detection program for detecting welding defects, the detection program causing a control device to achieve the functions of obtaining at least an image of a welding location during welding, extracting information regarding at least a porosity defect among the welding defects on a basis of the image, classifying the porosity defect into one of two or more occurrence types of porosity defect on a basis of the information regarding at least the porosity defect, and extracting at least one occurrence type of porosity defect and calculating quantitative data relating to the porosity defect.

(6) A method for detecting welding defects, the method including a first step of obtaining at least an image of a welding location during welding, a third step of classifying a porosity defect into one of two or more occurrence types of welding defect on a basis of the image and information regarding the welding defects, and a fourth step of extracting at least one occurrence type of welding defect and calculating quantitative data relating to the welding defect.

According to the present invention, welding defects can be detected for each of factors causing welding defects.

### BRIEF DESCRIPTION OF THE DRAWINGS

FIG. 1 is a schematic diagram illustrating an example of configuration of a welding system according to an embodiment;

FIG. 2 is a perspective view for explaining an arrangement position of an imaging device according to the embodiment;

FIG. 3 is a perspective view for explaining arrangement positions of a plurality of imaging devices according to the embodiment;

FIG. 4 is a block diagram illustrating an example of configuration of a data processing device according to the embodiment;

FIG. 5 is a diagram illustrating an example of a process for detecting welding defects according to the embodiment using a trained model;

FIG. 6 is a diagram illustrating an example of the output amount of bubbles according to the embodiment; and

FIG. 7 is a diagram illustrating an example of a display screen on a display unit according to the embodiment.

### DESCRIPTION OF THE PREFERRED EMBODIMENTS

A welding system according to an embodiment of the present invention will be described hereinafter with reference to the drawings. In the drawings, the same components are given the same reference numerals to indicate correspondences. The welding system in the present invention is suitable for a portable welding robot, but is not limited to a configuration according to the present embodiment. For example, the welding system in the present invention may also be employed for a six-axis welding robot and an automatic welding apparatus including a driving unit such as a carriage. Although the present embodiment selects single-sided welding in a horizontal position as an example, a type of welding to be performed is not limited to this, and any execution method and welding position may be used.

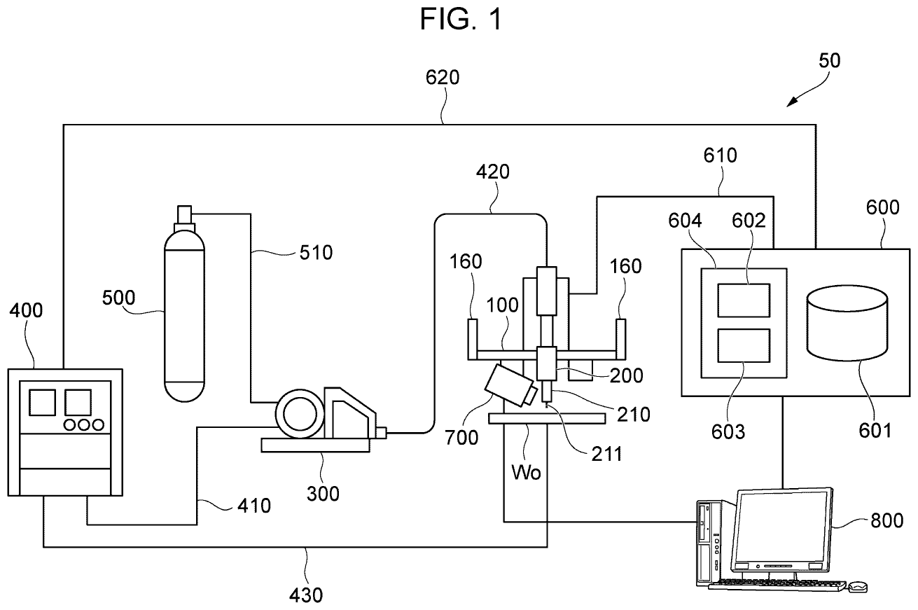

FIG. 1 is a schematic diagram illustrating an example of configuration of the welding system according to the present embodiment. A welding system 50 includes a portable welding robot 100, a feeding device 300, a welding power supply 400, a shielding gas supply source 500, a robot control device 600, an imaging device 700, and a data processing device 800. As described above, when features of the present embodiment are applied to a six-axis welding robot, an automatic welding apparatus including a driving unit such as a carriage, or the like, additional components may also be included in accordance with a configuration to be achieved. Components of the welding system 50 are communicably connected to each other by one of various wired or wireless communication methods. The number of communication methods to be used is not limited to one, and a plurality of communication methods may be combined for the connection.

### Robot Control Device

The robot control device 600 is connected to the portable welding robot 100 by a robot control cable 610 and to the welding power supply 400 by a power supply control cable 620. The robot control device 600 includes a data holding unit 601 that holds in advance teaching data that defines operation patterns, welding start positions, welding end positions, execution conditions, welding conditions, a parameter table (hereinafter also referred to as a “condition database”), and the like of the portable welding robot 100, and transmits instruction information to the portable welding robot 100 and the welding power supply 400 as commands on the basis of the teaching data to control operation of the portable welding robot 100 and the welding conditions.

The robot control device 600 may also include a groove shape information calculation section 602 that calculates groove shape information from detection data obtained by performing sensing, such as touch sensing, before welding and a welding condition obtaining section 603 that performs layer design on the basis of at least one of the groove shape information and the condition database and that obtains the welding conditions of the teaching data for each pass by setting the welding conditions. The groove shape information calculation section 602 and the welding condition obtaining section 603 constitute a control unit 604. The control unit 604 includes, for example, a central processing unit (CPU), a micro-processing unit (MPU), a digital signal processor (DSP), or a field-programmable gate array (FPGA). Although the welding conditions are set in the present embodiment using the most preferable sensing from the perspective of efficiency, the setting of the welding conditions is not limited to this, and, for example, the welding conditions may be set by directly performing teaching, instead. In the present invention, a sensing position or a teaching position (hereinafter also referred to as a “teaching point”) in an initial layer (hereinafter also referred to as a “first layer”) may be any position on a welding start side. Any position on the welding start side refers to a welding start position or a position near the welding start position. Although the welding start position is employed from the perspective of accuracy of the groove shape information in the present embodiment, the welding conditions at the welding start position may be set on the basis of the groove shape information near the welding start position, instead.

The layer design refers to determinations of an appropriate number of layers and an appropriate number of passes for a given groove. The number of layers refers to the number of welding beads stacked in a plate thickness direction. In layer design of multi-layer welding, it is generally assumed as a basic principle that deposition height is kept constant in each layer. It is therefore preferable to perform the layer design on the basis of the groove shape information and set or correct the welding conditions on the basis of calculated layer design information. Here, the layer design information may include the number of layers, the number of passes, and the deposition height (≈height of each pass), but the welding conditions are determined on the basis of at least the calculated deposition height. For example, when it is found as a result of sensing that a gap is larger at the welding end position than at the welding start position, the amount of deposition needs to be gradually increased to make the deposition height constant, since gap width increases as the welding progresses. At this time, welding conditions relating to the amount of deposition include wire feed speed and welding speed, and these welding conditions may be set or corrected on the basis of the groove shape information and the layer design information.

The welding power supply 400 supplies power to a welding wire 211, which is a consumable electrode, and a workpiece Wo on the basis of a command from the robot control device 600 to generate an arc between the welding wire 211 and the workpiece Wo. The power from the welding power supply 400 is sent to the feeding device 300 via a power cable 410, and then sent to a welding torch (hereinafter referred to as a “torch”) 200 from the feeding device 300 via a conduit tube 420. The power from the welding power supply 400 is then supplied to the welding wire 211 via a contact tip at a distal end of the torch 200. A current during welding work may be a direct current or an alternating current, and a waveform thereof is not particularly limited. The current, therefore, may be a pulse such as a rectangular wave or a triangular wave.

For example, the welding power supply 400 is connected to a torch 200 side using the power cable 410 as a positive electrode and to a workpiece Wo side using a power cable 430 as a negative electrode. This applies when welding is performed with reverse polarity, and when welding is performed with direct polarity, a power cable as a positive electrode may be connected to the workpiece Wo side, and a power cable as a negative electrode may be connected to the torch 200 side.

### Shielding Gas Supply Source

The shielding gas supply source 500 includes a container filled with a shielding gas and ancillary components including a valve. The shielding gas supply source 500 sends the shielding gas to the feeding device 300 via a gas tube 510. The shielding gas sent to the feeding device 300 is sent to the torch 200 via the conduit tube 420. The shielding gas sent to the torch 200 flows through the torch 200, is guided to a nozzle 210, and is ejected from the distal end of the torch 200. The shielding gas used in the present embodiment may be, for example, argon (Ar), carbon dioxide (CO₂), or a mixture of these.

The conduit tube 420 according to the present embodiment is formed with a conductive path on an outer surface of a tube to function as a power cable, and a protective tube for protecting the welding wire 211 is disposed inside the tube to provide a flow path for the shielding gas. The conduit tube 420, however, is not limited to this, and, for example, a bundle in which a power supply cable and a hose for supplying the shielding gas are gathered around a protective tube for feeding the welding wire 211 to the torch 200 may be used, instead. Alternatively, for example, a tube for feeding the welding wire 211 and the shielding gas and a power cable may be separately provided.

### Feeding Device

The feeding device 300 feeds the welding wire 211 to the torch 200. The welding wire 211 fed by the feeding device 300 is not particularly limited, and is selected on the basis of characteristics of the workpiece Wo, a welding mode, and the like, and, for example, solid wire or flux-cored wire is used. A diameter of the welding wire 211 is not particularly limited, but a preferable diameter in the present embodiment is 1.6 mm at maximum and 0.9 mm at minimum.

In the present embodiment, detection means is a touch sensor that applies a voltage between the workpiece Wo and the welding wire 211 and that senses a surface of a groove or the like using a voltage drop phenomenon caused when the welding wire 211 comes into contact with the workpiece Wo. The detection means is not limited to the touch sensor according to the present embodiment, and may be an image sensor, a laser sensor, or the like or a combination of these, but the touch sensor according to the present embodiment is preferably used for simplicity of device configuration.

### Imaging Device

The imaging device 700 (hereinafter also referred to as a “visual sensor” or a “camera”) includes, for example, a camera including a complementary metal-oxide-semiconductor (CMOS) sensor as a visual sensor. The imaging device 700 may be directly attached to the portable welding robot 100, or may be fixed at a particular nearby position. An imaging device 701 described later with reference to FIG. 3 may have the same configuration as the imaging device 700.

Image information obtained by the imaging device 700 and the imaging device 701 described later is transmitted to the data processing device 800 and used in the data processing device 800. At this time, the data processing device 800 may extract any images at predetermined intervals from the obtained image information, for example, and use the images for processing described later. An extraction method and extraction settings used here may be switched, for example, in accordance with configuration and functions of the imaging devices 700 and 701, performance of the data processing device 800, and the like.

In the present embodiment, a moving image is captured as a welding image while including at least a welding location including a weld pool in an imaging range as an object (target) to be included in image data using the imaging device 700 directly attached and fixed to the portable welding robot 100. Here, the “welding location” is any location on a weld line. Alternatively, a moving image may be captured as a welding image such that the imaging range further includes the workpiece Wo, the welding wire 211, and the arc.

Various imaging settings relating to a welding image may be specified in advance, or may be switched in accordance with operation conditions of the welding system 50. The imaging settings include, for example, a frame rate, the number of pixels of an image, resolution, and shutter speed.

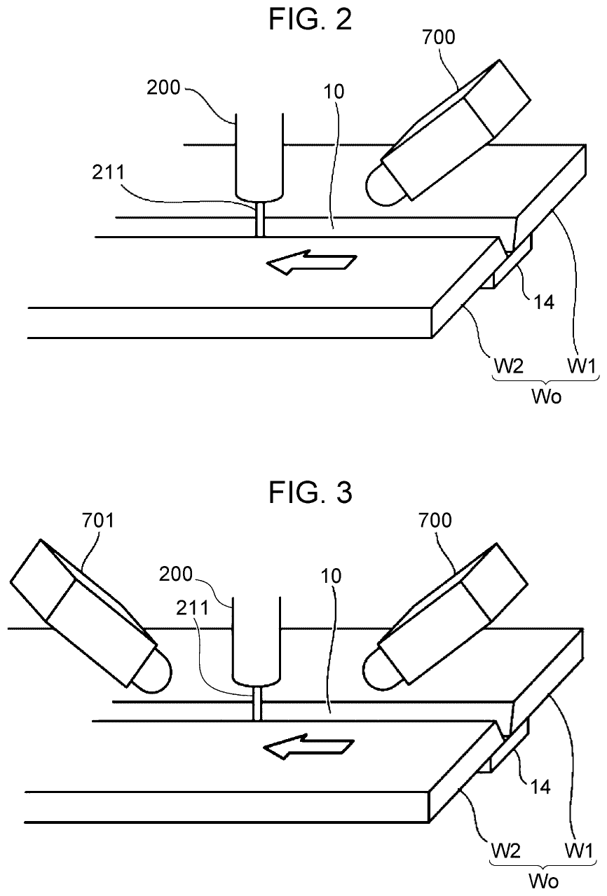

FIG. 2 is a perspective view for explaining an arrangement position of the imaging device 700 according to the present embodiment. Since directions of the torch 200 and the groove differ depending on a welding position, directions illustrated in FIG. 2 are examples. In the present embodiment, the workpiece Wo is a butt joint. The workpiece Wo is two metal plates butted together with a groove therebetween. A horizontal position is taken as an example in the present embodiment, and in this case, an upper-plate portion of the workpiece Wo will be denoted by W1 (hereinafter referred to as an “upper plate W1”), and a lower-plate portion of the workpiece Wo will be denoted by W2 (hereinafter referred to as a “lower plate W2”). A ceramic backing material 14 is attached to back surfaces of the two plates W1 and W2 of the workpiece Wo butted together. A metal backing material may be used as the backing material 14, or no backing material may be provided, instead. That is, a type of backing material is not particularly limited, and may differ depending on a material of the workpiece Wo or the like. In a butt joint, arc welding is performed in one direction along a groove. In the following description, a direction in which welding progresses will be referred to as a “weld line direction”. In FIG. 2, an arrow indicates the direction in which the welding progresses. The imaging device 700, therefore, is located behind the torch 200. A position of the imaging device 700 is not limited to behind the torch 200, but when porosity defects, which will be described later, are to be detected, accuracy of detecting the porosity defects improves if the imaging device 700 is arranged behind the torch 200.

FIG. 3 is a perspective view for explaining arrangement positions of the plurality of imaging devices 700 and 701 according to the present embodiment. Description of the same parts as those in the embodiment illustrated in FIG. 2 is omitted. In FIG. 3, the imaging device 701 is also provided in addition to the imaging device 700. The imaging device 701 is positioned ahead of the torch 200. The imaging device 701 arranged ahead of the torch 200 is mainly used to control the welding speed, and may be arranged as illustrated in FIG. 3 when it is desired to perform the welding speed control along with the defect detection in the present invention. The imaging device 700 arranged behind of the torch 200 is mainly used for the detection of welding defects according to the embodiment of the present disclosure.

Visual sensors of the imaging devices 700 and 701 according to the present embodiment are capable of successively capturing, for example, still images of 1,024×768 pixels. In other words, the imaging devices 700 and 701 are capable of capturing a moving image as a welding image. Resolution of still images that can be captured by the imaging devices 700 and 701 is not particularly limited. For example, the imaging devices 700 and 701 may capture welding images of different levels of resolution. Before welding images are input to a trained model described later, preprocessing for reducing processing time, such as extraction of any feature region from captured welding images, may be performed. The feature region may have a range of a fixed size set in such a way as to dispose a predetermined region at the center thereof. Size of the feature region may be changed in accordance with a welding situation.

### Data Processing Device

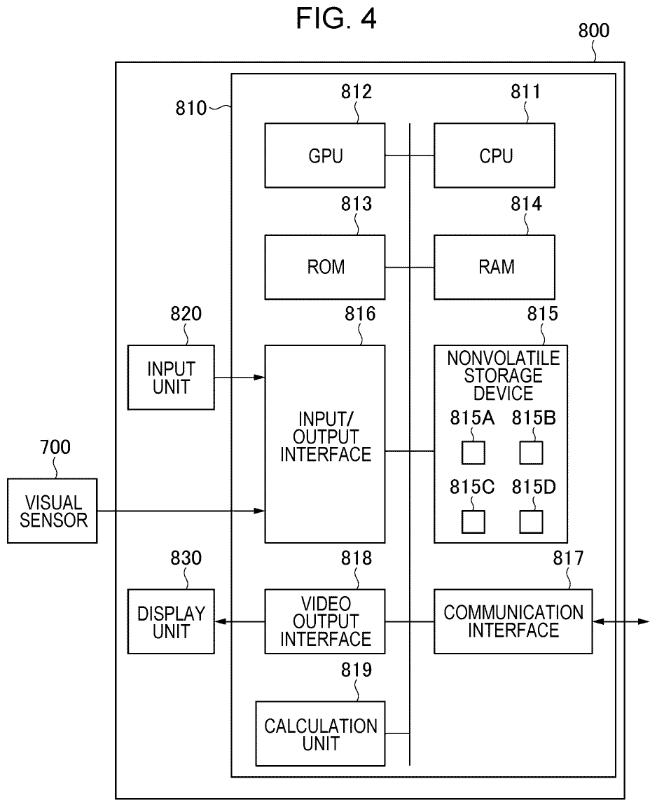

FIG. 4 is a block diagram illustrating an example of configuration of the data processing device 800 according to the present embodiment. The data processing device 800 is a control device and includes, for example, a computer. The computer includes a main body 810, an input unit 820, and a display unit 830. The main body 810 includes a CPU 811, a graphical processing unit (GPU) 812, a read-only memory (ROM) 813, a random-access memory (RAM) 814, a nonvolatile storage device 815, an input/output interface 816, a communication interface 817, a video output interface 818, and a calculation unit 819. The CPU 811, the GPU 812, the ROM 813, the RAM 814, the nonvolatile storage device 815, the input/output interface 816, the communication interface 817, the video output interface 818, and the calculation unit 819 are communicably connected to each other by a bus or a signal line.

The nonvolatile storage device 815 stores a learning program 815A for executing machine learning using predetermined learning data, a trained model 815B generated by executing the learning program 815A, a quantitative data generation program 815C for generating quantitative data using the trained model 815B, and image data 815D. An operating system and application programs are also installed on the nonvolatile storage device 815.

When the CPU 811 and the GPU 812 execute programs, the data processing device 800 achieves various functions. In the present embodiment, the data processing device 800 achieves a function of generating a trained model by machine learning and a function of performing various types of processing using the trained model. Details of the functions will be described later. The data processing device 800 may be divided in accordance with the function of generating a trained model and a function of performing control processing on the basis of information output from the trained model during actual welding. From the viewpoint of versatility, it is more preferable that the data processing device 800 be divided in accordance with the individual functions. The GPU 812 is used as a calculation device at a time when the learning program 815A and the quantitative data generation program 815C are executed. The ROM 813 stores a basic input/output system (BIOS) and the like to be executed by the CPU 811. The RAM 814 is used as a work area of a program read from the nonvolatile storage device 815.

The input/output interface 816 is connected to the input unit 820 such as a keyboard and a mouse. The imaging devices 700 and 701, which are visual sensors, are also connected to the input/output interface 816. Image data output from the imaging devices 700 and 701 is given to the CPU 811 via the input/output interface 816. The communication interface 817 is a communication module for wired or wireless communication. The video output interface 818 is connected to the display unit 830 including, for example, a liquid crystal display or an organic electroluminescent (EL) display, and outputs a video signal according to video data given from the CPU 811 to the display unit 830. The calculation unit 819 performs various types of processing such as calculation of quantitative data relating to porosity defects according to the present embodiment and calculation of geometrical quantities to be used to control the welding speed, for example, in coordination with the CPU 811 and the GPU 812.

### Generation of Trained Model

The trained model 815B according to the present embodiment is achieved by a convolutional neural network and includes a plurality of convolutional layers and a plurality of pooling layers. Configuration of the convolutional neural network is not limited to this, and the number of layers and components may be different.

The trained model 815B receives, as input data, information based on welding images output from the imaging devices 700 and 701. As described later, with respect to the input data obtained from the imaging device 700, the trained model 815B outputs information from which information regarding quantitative data relating to porosity defects can be derived for each of types provided for different factors causing the porosity defects (hereinafter also referred to as “occurrence types”). With respect to the input data obtained from the imaging device 701, the trained model 815B outputs information from which information regarding geometrical quantities to be used to control the welding speed can be derived. The present embodiment relating to the imaging device 700 will be described hereinafter. Captured images that are original information input to the trained model 815B show at least a weld pool as an object, that is, a target. The captured images may also show a welding wire, an arc, and other objects. By receiving information based on imaging information, the trained model 815B outputs information from which quantitative data relating to porosity defects of different occurrence types can be derived. The information based on the imaging information may be the captured images themselves, or may be information obtained by performing some information processing, such as preprocessing, on the captured images. The information regarding the quantitative data relating to porosity defects of different occurrence types may be quantitative data itself. The information from which the quantitative data relating to porosity defects of different occurrence types can be derived may be information from which the quantitative data can be derived by performing some information processing on the information.

The data processing device 800 calculates quantitative data relating to porosity defects of any occurrence type by inputting the information based on the captured images from the imaging device 700 to the trained model 815B.

### Detection of Welding Defects

The welding system 50 in the present disclosure detects welding defects. The welding defects include, for example, pits and blowholes. The imaging device 700 captures images of a welding location in real-time. The data processing device 800 obtains the captured images of the welding location. The captured images of the welding location are abbreviated as welding images or captured images herein. The welding location includes at least a weld pool. The welding location may further include portions other than the weld pool, and more preferably includes a welding wire and an arc.

The data processing device 800 extracts information regarding welding defects on the basis of the welding images. At this time, since information regarding porosity defects such as pits and blowholes is important in performing welding, it is preferable to extract at least the information regarding porosity defects among welding defects. The information regarding porosity defects includes information regarding bubbles caused in the weld pool. The information regarding porosity defects may include information indicating porosity defects other than bubbles.

In the present embodiment, the data processing device 800 classifies the information regarding porosity defects into two or more occurrence types of porosity defect. As the occurrence types of porosity defect, for example, at least one of porosity defects caused by shielding gas failure, porosity defects originating from plating, such as in a galvanized steel plate, and porosity defects caused by moisture and oil adhering to a surface of a steel plate may be selected. For example, in the present embodiment, the two occurrence types are porosity defects caused by shielding gas failure and porosity defects for other reasons (porosity defects caused by anything other than shielding gas failure). Occurrence types of porosity defect other than the above three types may also be provided.

The occurrence types of porosity defect may be provided on the basis of at least one of an occurrence position in the weld pool and luminance of bubbles. Different ranges of the occurrence position in the weld pool may be provided on the basis of luminance of the weld pool, and bubbles caused in the different ranges may be classified into different occurrence types of porosity defect.

The data processing device 800 extracts at least one occurrence type of porosity defect and calculates quantitative data relating to porosity defects. The quantitative data refers to countable information represented by numerical values. For example, the quantitative data relating to porosity defects includes the amount of bubbles, which will be described later. Furthermore, when shielding gas failure also occurs, the quantitative data relating to porosity defects also includes the amount of sputter because the amount of sputter also changes. Here, the amount of bubbles includes area of bubbles, a ratio between the area of bubbles and area of the weld pool, and frequency. The quantitative data relating to porosity defects may also include other values correlated with various values including the amount of bubbles and the amount of sputter.

The value relating to the amount of bubbles may be a value calculated on the basis of at least one of the number, area, and duration of bubbles. The value relating to the amount of bubbles may be the number of bubbles, total area occupied by bubbles, or duration of bubbles. The value relating to the amount of bubbles may be a value obtained by combining two or more of these values. For example, a value obtained by multiplying the area occupied by bubbles and the frequency of bubbles corresponds to the value relating to the amount of bubbles. The value relating to the amount of bubbles may be calculated for each of bead positions or time periods.

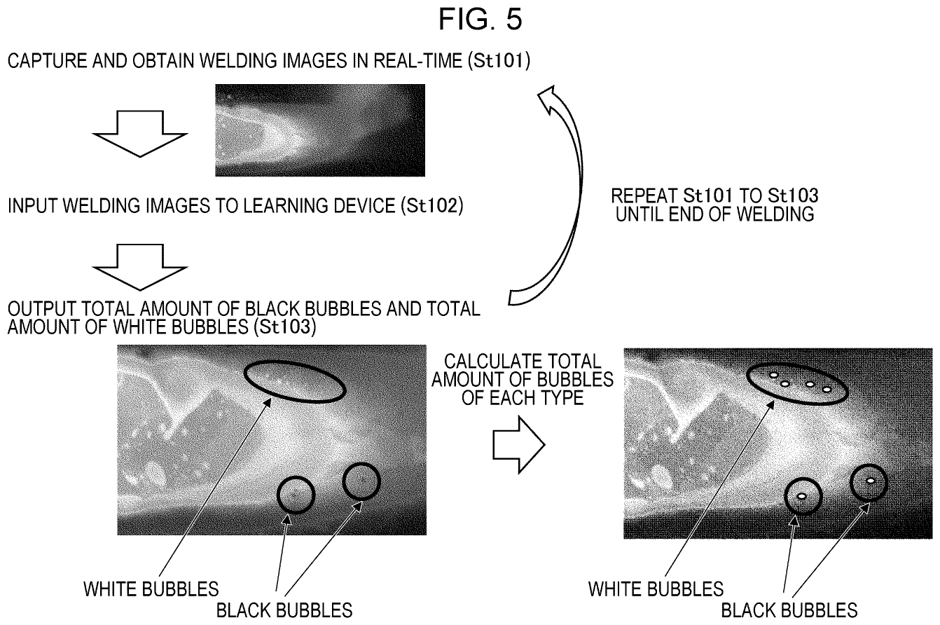

The welding system 50 may achieve the above-described process for detecting welding defects using a trained model. FIG. 5 is a diagram illustrating an example of the process for detecting welding defects according to the present embodiment using a trained model.

The welding system 50 calculates the quantitative data relating to porosity defects of any occurrence type by inputting information based on images to a learning device that includes the trained model 815B, whose input is the information based on the images and whose output is information from which quantitative data relating to porosity defects of different occurrence types. The learning device in this example corresponds to the main body 810 included in the data processing device 800 illustrated in FIG. 4.

In the example of the process illustrated in FIG. 5, information regarding, among welding defects, porosity defects including information regarding bubbles caused in the weld pool is extracted. Two occurrence types of porosity defect are provided in this example, and whether bubbles are white bubbles whose luminance is higher than a predetermined threshold or black bubbles whose luminance is lower than the predetermined threshold is determined on the basis of luminance of the bubbles. The white bubbles correspond to porosity defects caused by shielding gas failure. The black bubbles correspond to porosity defects caused by factors other than shielding gas failure. The quantitative data in this example is the amount of bubbles, which is the sum of pixels of bubbles shown in an image.

Welding beads also contain slag, and it is important whether bubbles shown in an image can be correctly extracted. Whereas bubbles, once caused, quickly burst and disappear, slag and other elements other than bubbles do not immediately disappear. Therefore, bubbles and slag may be distinguished from each other in captured images on the basis of temporal changes of welding images captured as a moving image, and bubbles may be extracted.

The imaging device 700 captures welding images, which are images of the welding location, in real-time. The data processing device 800 obtains the captured welding images (St101).

The data processing device 800 inputs the welding images to the learning device (main body 810) (St102). The data processing device 800 calculates the amount of white bubbles and the amount of black bubbles from the images of the welding location and outputs the amount of white bubbles and the amount of black bubbles (St103).

The imaging device 700 and the data processing device 800 repeat the processing in steps St101 to St103 until the welding ends.

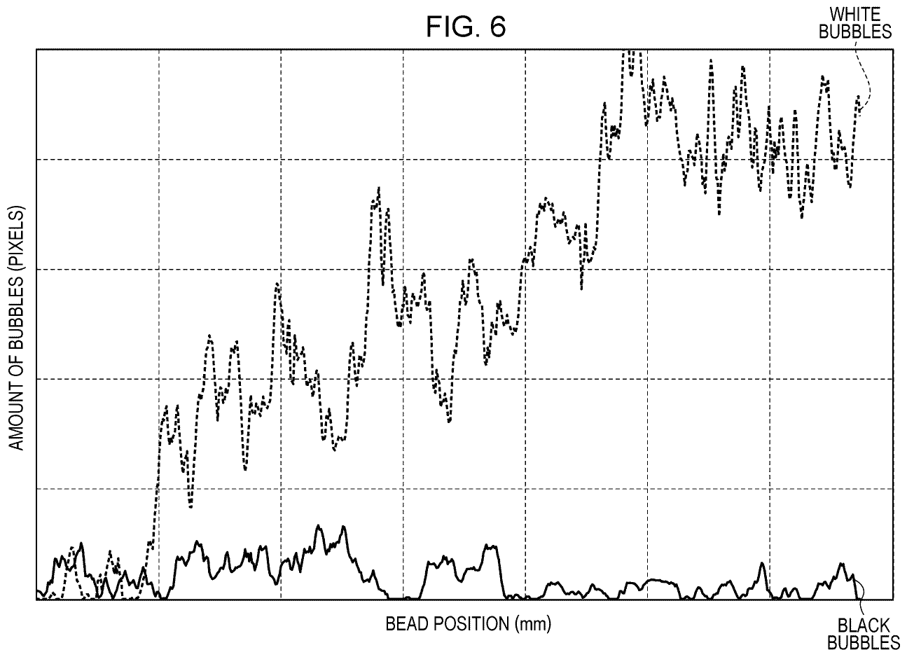

FIG. 6 is a diagram illustrating an example of the output amount of bubbles according to the present embodiment. As described above, the data processing device 800 outputs the amount of bubbles for each of different bead positions. In FIG. 6, a horizontal axis represents the bead position, and a vertical axis represents the amount of bubbles. As illustrated, the amount of bubbles is output for each of the types of porosity defect.

### Evaluation of Welding Defects Based on Detection Result

As described above, after the quantitative data relating to porosity defects of any occurrence type is calculated, the data processing device 800 predicts prediction target information on the basis of the quantitative data. The prediction target information may be, for example, presence or absence of welding defects during welding, welding defect information indicating content of welding defects after welding, the amount of any element contained in molten metal, or the amount of deposits on a surface of a workpiece. The amount of any element may be the amount of nitrogen, for example, but may be the amount of another element. The deposits on the surface of a workpiece may be deposits including plating. The data processing device 800 evaluates presence or absence of welding defects on the basis of a predicted value of the prediction target information. The data processing device 800 may evaluate presence or absence of porosity defects on the basis of the predicted value of the prediction target information.

When presence or absence of welding defects during welding is determined as the prediction target information, for example, a threshold is provided in advance for the amount of bubbles, which is quantitative data, and presence or absence of welding defects may be determined on the basis of the threshold. When the amount of nitrogen contained in the molten metal is predicted as the prediction target information, a correlation between the amount of bubbles, which is quantitative data for evaluating welding defects, and the amount of nitrogen in the molten metal is analyzed in advance, and a relational expression is constructed. For example, the relational expression is stored in the data processing device 800.

As described above, the data processing device 800 calculates the amount of nitrogen in the molten metal in real-time on the basis of the output amount of bubbles and the stored relational expression. The data processing device 800 predicts whether welding defects will occur in real-time on the basis of the calculated amount of nitrogen. For example, when there is a positive correlation where the amount of bubbles also increases as the amount of nitrogen in the molten metal increases, a relational expression for outputting a predicted value of the amount of nitrogen on the basis of the input amount of bubbles is stored in the data processing device 800. Here, for example, if machine characteristics deteriorate with the amount of nitrogen in the molten metal in a predetermined first range and blowholes occur with the amount of nitrogen in the molten metal in a second range, the data processing device 800 predicts the amount of nitrogen on the basis of the output amount of bubbles and the relational expression as described above and evaluates presence or absence of welding defects on the basis of the predicted value of the amount of nitrogen.

When deterioration of the machine characteristics or porosity defects are detected, some type of control may be additionally performed. For example, movement of the various devices included in the welding system 50 may be stopped, or setting values for operating the various devices may be changed.

### Display Example

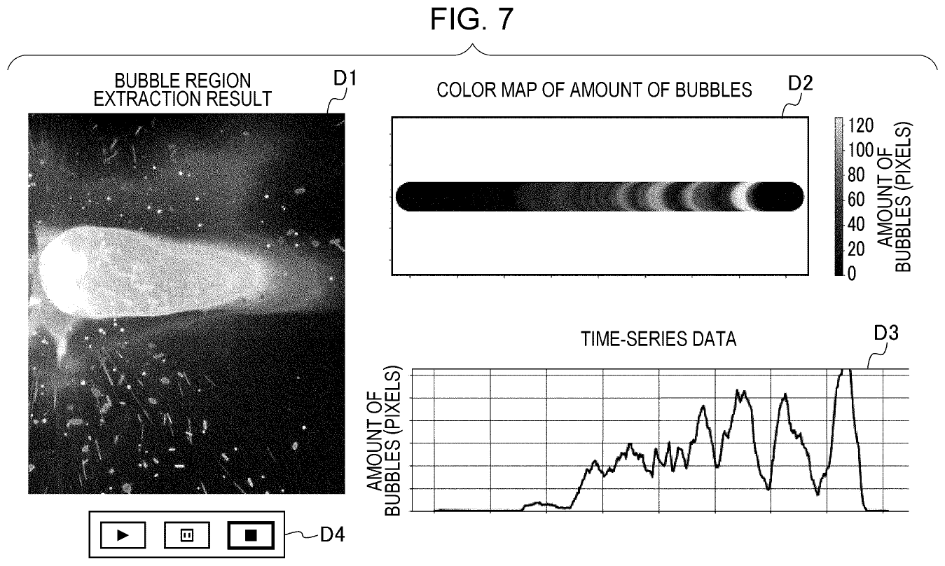

FIG. 7 is a diagram illustrating an example of a display screen on the display unit 830 according to the present embodiment. The display screen on the display unit 830 displays a bubble region extraction result D1, a color map D2, a time-series data D3, and a control box D4.

As the bubble region extraction result D1, welding images captured by the imaging device 700 are displayed as a moving image.

The color map D2 is a color map indicating value ranges of quantitative data using different colors. In this example, a bubble amount color map indicating a value range of the amount of bubbles at each of bead positions using a color is displayed.

The time-series data D3 is a line graph indicating quantitative data at each of bead positions or for each of counts of images captured by the imaging device 700. In this example, a line graph indicating the amount of bubbles for each of counts of captured images is displayed.

The control box D4 includes buttons for playing, pausing, and stopping the moving image displayed as the bubble region extraction result D1.

### Modifications

In the above embodiment, the imaging device 700 captures welding images, and welding defects are detected using the welding images. In a modification, for example, sound during welding may be collected using a microphone or the like, and welding defects may be detected using a combination of audio data and welding images.

As described with reference to FIG. 3, a plurality of imaging devices 700 and 701 may be prepared, welding defects may be detected from images obtained by the imaging device 700, and welding conditions may be controlled from images obtained by the imaging device 701. As the trained model 815B, a trained model that outputs feature points relating to welding or geometrical quantities obtained from the feature points in response to welding images obtained by and received from the imaging device 701 may be provided. Here, the feature points relating to welding include a tip of a welding wire, a central point of an arc, positions of left and right tips (upper and lower tips in the case of the horizontal position) of a weld pool in the welding progress direction, and positions of left and right ends (upper and lower ends in the case of the horizontal position) of the weld pool in the welding progress direction. Examples of the geometrical quantities obtained from feature points include distances between the welding wire and the tips of the weld pool in the weld line direction, width of the weld pool, and area of the weld pool. The welding conditions including the welding speed may be controlled on the basis of such geometrical quantity data.

The robot control device 600 and the data processing device 800 may be integrated together. Processing supposed to be performed by the robot control device 600 may be performed by the data processing device 800, instead, and processing supposed to be performed by the data processing device 800 may be performed by the robot control device 600, instead, within a range that does not cause a contradiction. Other devices may perform processing supposed to be performed by the robot control device 600 or the data processing device 800, instead.

The present invention is not limited to the above-described embodiment and is also intended to encompass combinations of the features of the embodiment, as well as modifications and applications that those skilled in the art can make on the basis of the description in the specification and known techniques, which are included within the scope of the claims.

As described above, the specification discloses the following items.

(1) A method for detecting welding defects, the method including a first step of obtaining at least an image of a welding location during welding, a second step of extracting information regarding at least a porosity defect among the welding defects on a basis of the image, a third step of classifying the porosity defect into one of two or more occurrence types of porosity defect on a basis of the information regarding at least the porosity defect, and a fourth step of extracting at least one occurrence type of porosity defect and calculating quantitative data relating to the porosity defect.

(2) The method for detecting welding defects according to (1), in which, in the second step, the information regarding at least the porosity defect includes information regarding bubbles caused in a weld pool, in which in the third step, the two or more occurrence types of porosity defect are two or more bubble occurrence types, and in which, in the fourth step, the quantitative data relating to the porosity defect for at least one of the two or more bubble occurrence types is a value relating to an amount of bubbles.

(3) The method for detecting welding defects according to (2), in which the value relating to the amount of bubbles is a value calculated on a basis of at least one of a number, area, and duration.

(4) The method for detecting welding defects according to (2), in which the two or more occurrence types of porosity defect are provided on a basis of at least one of an occurrence position in the weld pool and luminance of the bubbles.

(5) The method for detecting welding defects according to (4), in which different ranges of the occurrence position in the weld pool are provided on a basis of luminance of the weld pool, and in which bubbles caused in each range are classified into a corresponding occurrence type of porosity defect.

(6) The method for detecting welding defects according to (1), further including a step of calculating quantitative data relating to any occurrence type of porosity defect by inputting information based on the image to a learning device including a trained model whose input is the information based on the image and whose output is information from which quantitative data relating to the at least one occurrence type of porosity defect can be derived.

(7) A method for evaluating welding defects, the method including a first step of obtaining at least an image of a welding location during welding, a second step of extracting information regarding at least a porosity defect among the welding defects on a basis of the image, a third step of classifying the porosity defect into one of two or more occurrence types of porosity defect on a basis of the information regarding at least the porosity defect, a fourth step of extracting at least one occurrence type of porosity defect and calculating quantitative data relating to the porosity defect, a fifth step of predicting welding defect information after the welding, an amount of any element contained in molten metal, or an amount of deposits on a surface of a workpiece on a basis of the quantitative data, and a sixth step of evaluating presence or absence of at least the porosity defect on a basis of a predicted value of the welding defect information, the amount of any element, or the amount of deposits.

(8) A control device for detecting welding defects, the control device including a control unit, in which the control unit obtains at least an image of a welding location during welding, extracts information regarding at least a porosity defect among the welding defects on a basis of the image, classifies the porosity defect into one of two or more occurrence types of porosity defect on a basis of the information regarding at least the porosity defect, extracts at least one occurrence type of porosity defect, and calculates quantitative data relating to the porosity defect.

(9) The control device according to (8), further including a display unit, in which the display unit displays at least value ranges of the quantitative data using different colors.

(10) A welding system for detecting welding defects, the welding system including a control device, in which the control device obtains at least an image of a welding location during welding, extracts information regarding at least a porosity defect among the welding defects on a basis of the image, classifies the porosity defect into one of two or more occurrence types of porosity defect on a basis of the information regarding at least the porosity defect, extracts at least one occurrence type of porosity defect, and calculates quantitative data relating to the porosity defect.

(11) The welding system according to (10), further including a display unit, in which the display unit displays at least value ranges of the quantitative data using different colors.

(12) A detection program for detecting welding defects, the detection program causing a control device to achieve the functions of obtaining at least an image of a welding location during welding, extracting information regarding at least a porosity defect among the welding defects on a basis of the image, classifying the porosity defect into one of two or more occurrence types of porosity defect on a basis of the information regarding at least the porosity defect, and extracting at least one occurrence type of porosity defect and calculating quantitative data relating to the porosity defect.

(13) A method for detecting welding defects, the method including a first step of obtaining at least an image of a welding location during welding, a third step of classifying a porosity defect into one of two or more occurrence types of welding defect on a basis of the image and information regarding the welding defects, and a fourth step of extracting at least one occurrence type of welding defect and calculating quantitative data relating to the welding defect.

What is claimed is:

1. A method for detecting welding defects, the method comprising:
a first step of obtaining at least an image of a welding location during welding;
a second step of extracting information regarding at least a porosity defect among the welding defects on a basis of the image;
a third step of classifying the porosity defect into one of two or more occurrence types of porosity defect on a basis of the information regarding at least the porosity defect; and
a fourth step of extracting at least one occurrence type of porosity defect and calculating quantitative data relating to the porosity defect.

2. The method for detecting welding defects according to claim 1,
wherein, in the second step, the information regarding at least the porosity defect includes information regarding bubbles caused in a weld pool,
wherein, in the third step, the two or more occurrence types of porosity defect are two or more bubble occurrence types, and
wherein, in the fourth step, the quantitative data relating to the porosity defect for at least one of the two or more bubble occurrence types is a value relating to an amount of bubbles.

3. The method for detecting welding defects according to claim 2,
wherein the value relating to the amount of bubbles is a value calculated on a basis of at least one of a number, area, and duration.

4. The method for detecting welding defects according to claim 2,
wherein the two or more occurrence types of porosity defect are provided on a basis of at least one of an occurrence position in the weld pool and luminance of the bubbles.

5. The method for detecting welding defects according to claim 4,
wherein different ranges of the occurrence position in the weld pool are provided on a basis of luminance of the weld pool, and
wherein bubbles caused in each range are classified into a corresponding occurrence type of porosity defect.

6. The method for detecting welding defects according to claim 1, further comprising:
a step of calculating quantitative data relating to any occurrence type of porosity defect by inputting information based on the image to a learning device including a trained model whose input is the information based on the image and whose output is information from which quantitative data relating to the at least one occurrence type of porosity defect can be derived.

7. A method for evaluating welding defects, the method comprising:
a first step of obtaining at least an image of a welding location during welding;
a second step of extracting information regarding at least a porosity defect among the welding defects on a basis of the image;
a third step of classifying the porosity defect into one of two or more occurrence types of porosity defect on a basis of the information regarding at least the porosity defect;
a fourth step of extracting at least one occurrence type of porosity defect and calculating quantitative data relating to the porosity defect;
a fifth step of predicting welding defect information after the welding, an amount of any element contained in molten metal, or an amount of deposits on a surface of a workpiece on a basis of the quantitative data; and
a sixth step of evaluating presence or absence of at least the porosity defect on a basis of a predicted value of the welding defect information, the amount of any element, or the amount of deposits.

8. A control device for detecting welding defects, the control device comprising:
a control unit,
wherein the control unit obtains at least an image of a welding location during welding, extracts information regarding at least a porosity defect among the welding defects on a basis of the image, classifies the porosity defect into one of two or more occurrence types of porosity defect on a basis of the information regarding at least the porosity defect, extracts at least one occurrence type of porosity defect, and calculates quantitative data relating to the porosity defect.

9. The control device according to claim 8, further comprising:
a display unit,
wherein the display unit displays at least value ranges of the quantitative data using different colors.

10. A welding system for detecting welding defects, the welding system comprising:
a control device,
wherein the control device obtains at least an image of a welding location during welding, extracts information regarding at least a porosity defect among the welding defects on a basis of the image, classifies the porosity defect into one of two or more occurrence types of porosity defect on a basis of the information regarding at least the porosity defect, extracts at least one occurrence type of porosity defect, and calculates quantitative data relating to the porosity defect.

11. The welding system according to claim 10, further comprising:
a display unit,
wherein the display unit displays at least value ranges of the quantitative data using different colors.

12. A detection program for detecting welding defects, the detection program causing a control device to achieve the functions of:
obtaining at least an image of a welding location during welding;
extracting information regarding at least a porosity defect among the welding defects on a basis of the image;
classifying the porosity defect into one of two or more occurrence types of porosity defect on a basis of the information regarding at least the porosity defect; and
extracting at least one occurrence type of porosity defect and calculating quantitative data relating to the porosity defect.

13. A method for detecting welding defects, the method comprising:
a first step of obtaining at least an image of a welding location during welding;
a third step of classifying a porosity defect into one of two or more occurrence types of welding defect on a basis of the image and information regarding the welding defects; and
a fourth step of extracting at least one occurrence type of welding defect and calculating quantitative data relating to the welding defect.
